(19) United States
(12) Patent Application Publication
(10) Pub. No.: US 2023/0269853 A1
(43) Pub. Date: Aug. 24, 2023

(54) ALLOCATING CONTROL OF A LIGHTING DEVICE IN AN ENTERTAINMENT MODE

(71) Applicant: SIGNIFY HOLDING B.V., EINDHOVEN (NL)

(72) Inventor: HUGO JOSÉ KRAJNC, EINDHOVEN (NL)

(21) Appl. No.: 18/015,836

(22) PCT Filed: Jul. 1, 2021
(86) PCT No.: PCT/EP2021/068230

§ 371 Date: Jan. 12, 2023

(30) Foreign Application Priority Data
Jul. 13, 2020 (EP) 20185433.8

(51) Int. Cl. H05B 47/165

(52) U.S. Cl. CPC H05B 47/165

(57) ABSTRACT

A system (11) for allocating control of a lighting device (31) to a controller of a plurality of controllers (21, 45) is configured to detect that each of the plurality of controllers is analyzing a same content item for com rolling at least one light characteristic of the lighting device based on the analysis, determine the controller to which control of the at least one light characteristic of the lighting device is to be allocated to allocate the control to the controller, and prevent control of the at least one light characteristic of the lighting device by any other controller of the plurality of controllers.

### FIELD OF THE INVENTION

The invention relates to a system for allocating control of a lighting device to a controller of a plurality of controllers.

The invention further relates to a method of allocating control of a lighting device to a controller of a plurality of controllers.

The invention also relates to a computer program product enabling a computer system to perform such a method.

### BACKGROUND OF THE INVENTION

Philips' Hue Entertainment and Hue Sync have become very popular among owners of Philips Hue lights. Philips Hue Sync enables the rendering of light effects based on the content that is played on a computer, e.g. video games. A dynamic lighting system can dramatically influence the experience and impression of audio-visual material, especially when the colors sent to the lights match what would be seen in the composed environment around the screen.

This new use of light can bring the atmosphere of a video game or movie right into the room with the user. For example, gamers can immerse themselves in the ambience of the gaming environment and enjoy the flashes of weapons fire or magic spells and sit in the glow of the force fields as if they were real. Hue Sync works by observing analysis areas of the video content and computing light output parameters that are rendered on Hue lights around the screen. When the entertainment mode is active, the selected lighting devices in a defined entertainment area will play light effects in accordance with the content depending on their positions relative to the screen.

Initially, Hue Sync was only available as an application for PCs. An HDMI module called the Hue Play HDMI Sync Box was later added to the Hue entertainment portfolio. This device addresses one of the main limitations of Hue Sync and aims at streaming and gaming devices connected to the TV. It makes use of the same principle of an entertainment area and outputs similar light effects. This device is in principle a HDMI splitter which is placed between any HDMI device and TV.

In general, it is not only possible to analyze video content and control one or more lighting devices based on this analysis, as is done by the Hue Play HDMI Sync Box, but it is also possible to analyze audio content and control one or more lighting devices based on this analysis. For example, an app called Hue Disco analyzes an audio signal received from a microphone and controls one or more lighting devices based on this analysis. It is even possible to analyze both video content and audio content, which is disclosed in US 2014/072272 A1, for example.

All these apps/devices, also referred to as entertainment lighting controllers, have in common that they analyze a content item and control one or more lighting devices based on this analysis. It is becoming increasingly likely that multiple of these entertainment lighting controllers are used in the same lighting system and that two or more entertainment lighting controllers control or try to control the same lighting device(s). Since the type of analysis data that they use (e.g. raw audio, raw video, metadata from audio, metadata from video) may be significantly different and/or the used algorithms may be different, this may lead to potentially different light effects if they are used combined. Furthermore, even if both controllers create the same light effects, they might not be rendered at the same time and therefore disrupt the ambiance. This results in a degraded user experience.

### SUMMARY OF THE INVENTION

It is a first object of the invention to provide a system, which prevents a degraded user experience in a lighting system with multiple entertainment lighting controllers.

It is a second object of the invention to provide a method, which prevents a degraded user experience in a lighting system with multiple entertainment lighting controllers.

In a first aspect of the invention, a system for allocating control of a lighting device to a controller of a plurality of controllers comprises at least one input interface and at least one processor configured to detect, via said at least one input interface, that each of said plurality of controllers is analyzing a same content item for controlling at least one light characteristic of said lighting device based on said analysis, determine said controller, of said plurality of controllers, to which control of said at least one light characteristic of said lighting device is to be allocated to, allocate said control to said controller, and prevent control of said at least one light characteristic of said lighting device by any other controller of said plurality of controllers.

By having a system detect that a plurality of controllers is analyzing a same content item for controlling at least one light characteristic of a lighting device based on this analysis, this system can arbitrate between these controllers and allocate control to the most suitable controller. Thereby, a degraded user experience may be prevented. Which controller is most suitable may be determined based on contextual information obtained by the system.

Detecting that a plurality of controllers is analyzing a same content item may comprise receiving, via said at least one input interface, an indication of the content item (e.g. a numerical identifier, a name of a content item, a name or identifier of a source of a broadcasted content item) analyzed by each of the plurality of controllers. The indication received for each of the plurality of controllers may then be compared and if the indications of the content item analyzed match (e.g. the identifier is the same or similar, according to a predetermined rule for determining a match), the plurality of controllers is analyzing the same content item.

As an example, assuming there is a first controller and a second controller, the processor may receive via the at least one input interface a unique ID which identifies the content, such as an Entertainment Identifier Registry (EIDR) for video content or an International Standard Book Number (ISBN) for an audio book or a proprietary song ID of a music content service. The processor may then compare this indication of the content analyzed by the first controller to the indication of the content being analyzed by the second controller to determine whether or not they are the same.

Alternatively or additionally, detecting that a plurality of controllers is analyzing a same content item may comprise monitoring the control or output of the lighting device. Although the plurality of controllers may perform different analysis of the same content item (e.g. applying a different algorithm or the same algorithm yet with different settings), the light effects that are to be generated based on the analysis may have similarities. For example, color changes (e.g. for light effects based on video content, green in one scene and red in the next) or intensity changes may occur at the same time. Even though the exact color or intensity may be different, there may be a large degree (i.e. above a predetermined threshold, according to a formula for determining such) of similarities between the light effects.

Examples of light characteristics are color and brightness. For example, one controller may control the color of the lighting device and a further controller may control the brightness of the same lighting device. Alternatively, control of the at least one light characteristic of the lighting device by any other controller may be prevented by preventing any control of the lighting device by any other controller.

Said system may comprise at least one output interface and said at least one processor may be configured to instruct, via said at least one output interface, an intermediate node to prevent said control of said at least one light characteristic of said lighting device by said any other controller of said plurality of controllers. The intermediate node may be a bridge, for example. This is beneficial, for example, if it is not possible to instruct the one or more other controllers themselves. The intermediate note may be able to prevent control of the at least one light characteristic of the lighting device by not forwarding any commands received from the other controller(s) to the lighting device or by not forwarding commands specifying values for specific light characteristics to the lighting device.

Said system may comprise at least one output interface and said at least one processor may be configured to instruct, via said at least one output interface, said any other controller of said plurality of controllers not to control said at least one light characteristic of said lighting device, e.g. not to control said lighting device in general or not to control certain one or more light characteristics of said lighting device. This may be beneficial, for example, if the lighting system does not comprise an intermediate node, like a bridge.

Said at least one processor may be configured to allocate said control to said controller based on a comparison between an algorithm used by said controller for said analysis and any corresponding algorithm used by said any other controller for said analysis. For example, an algorithm that accesses not just the real-time content but also a certain number of seconds/frames ahead may be able to better prepare light transitions in between scenes of the video content.

Said at least one processor may be configured to allocate said control to said controller based on a comparison between a processing characteristic, processing capability and/or access to display settings and/or menu information of said controller with any corresponding processing characteristic, processing capability and/or access to display settings and/or menu information of said any other controller. As a first example, an HDMI module may need more time to analyze video content than a PC, i.e. has a lower processing capability, which results in a larger delay and may not preferred for that reason. As a second example, a processing characteristic of a PC is typically that the performance may fluctuate due to changes in processing load, which may result in a delay that is not constant and may not be preferred for that reason. Access to display settings and/or menu information, e.g. by an app running on a display device, may allow better light effects to be generated.

Said at least one processor may be configured to allocate said responsibility to said controller based on a characteristic of said content item. For example, an app running on a mobile device may be considered more suitable for analyzing audio content than an app running on a display device, because capturing the audio close to the user, i.e. with a microphone of the mobile device, might be more representative of how the user experiences the sound locally.

Said at least one processor may be configured to detect that a further controller of said plurality of controllers is analyzing said content item for controlling at least one light characteristic of a further lighting device based on said analysis, allocate control of said at least one light characteristic of said further lighting device to said controller, prevent control of said at least one light characteristic of said further lighting device by any controller other than said controller. Thus, control of multiple lighting devices may be allocated to the same controller.

Said system may comprise at least one output interface and said at least one processor may be configured to instruct, via said at least one output interface, said controller to control said at least one light characteristic of said further lighting device. If the controller is already controlling the lighting device but not the further lighting device, the controller may be instructed to control the further lighting device as well.

Said at least one processor may be configured to detect that a further controller of said plurality of controllers is analyzing said content item for controlling said at least one light characteristic of a further lighting device based on said analysis, allocate control of said at least one light characteristic of said further lighting device to said further controller, prevent control of said at least one light characteristic of said further lighting device by any controller other than said further controller. Thus, control of multiple lighting devices may be allocated to different controllers. Similarly, control of multiple light characteristics of the same lighting device may be allocated to different controllers.

Said at least one processor may be configured to allocate said control of said at least one light characteristic of said lighting device to said controller based on a position of said lighting device and allocate said control of said at least one light characteristic of said further lighting device to said further controller based on a position of said further lighting device. If control of multiple lighting devices is allocated to different controllers, a controller for controlling a lighting device may be selected based on the position of the controller. For example, the controller may control a first set of lighting devices in the front (e.g. near the display device) and the further controller may control a second set of lighting devices in the back.

Said at least one processor may be configured to allocate control of said at least one light characteristic of said lighting device for rendering light effects of a first type to said controller and allocate control of said at least one light characteristic of said further lighting device for rendering light effects of a second type to said further controller. For example, the controller may control the high dynamic light effects and the further controller may control the ambient light effects.

Said at least one processor may be configured to allocate said control of said at least one light characteristic of said lighting device to said controller at a first moment, prevent said control of said at least one light characteristic of said lighting device by any controller other than said controller upon allocating said control to said controller, allocate said control of said at least one light characteristic of said lighting device to a further controller of said plurality of controllers at a second moment, and prevent control of said at least one light characteristic of said lighting device by any controller other than said further controller upon allocating said control to said further controller. Thus, the allocation of control of the at least one light characteristic of the lighting device may change over time.

Said at least one processor may be configured to allocate said control of said at least one light characteristic of said lighting device to said controller at said first moment based on a load of said controller and/or a load of said further controller at said first moment and allocate said control of said at least one light characteristic of said lighting device to said further controller at said second moment based on a load of said controller and/or a load of said further controller at said second moment. By changing the allocation of control of the at least one light characteristic of the lighting device, typically of the lighting device in general, over time based on the load of the controllers, the user experience may be optimized. For example, if a PC has a low load, it may be allocated control of the lighting device to ensure a delay that is both low and constant and if the PC has a high load, an HDMI module may be allocated control of the lighting device to ensure a constant delay.

The lighting device and/or the further lighting device may be part of a lighting system which is external to the system according to the first aspect, although in an embodiment the system comprises the lighting device and/or the further lighting device. Likewise, the plurality of controllers may be external to the system according to the first aspect, without excluding that the one or more of the plurality of controllers is comprised in said system.

When the lighting device and/or further lighting device and/or one or more of the plurality of controllers are not part of the system according to the first aspect, said system may be communicatively coupled to aforementioned device(s) and/or controllers, for example via a wired or wireless connection. As an example, the system and the (further) lighting device may be part of the same network, such as a WiFi network or a Zigbee network, or part of different networks that are communicatively coupled, such as over the Internet, or they may be communicatively coupled over Bluetooth or via a cable. Likewise, the plurality of controllers may be part of such a network, for example a first controller may be a hardware device which is connected to a router of a home network via an Ethernet cable and a second controller may be a software application running on a computer which computer is connected to said router of the home network over WiFi. As yet another example, the system according to the first aspect may comprise the first controller of this example and not the second controller. The system may then comprise a hardware device such as an HDMI module, as the first controller in this example, and the second controller may then be the software application on the computer.

In a second aspect of the invention, a method of allocating control of a lighting device to a controller of a plurality of controllers comprises detecting that each of said plurality of controllers is analyzing a same content item for controlling at least one light characteristic of said lighting device based on said analysis, determining said controller, of said plurality of controllers, to which control of said at least one light characteristic of said lighting device is to be allocated to, allocating said control to said controller, and preventing control of said at least one light characteristic of said lighting device by any other controller of said plurality of controllers. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for allocating control of a lighting device to a controller of a plurality of controllers.

The executable operations comprise detecting that each of said plurality of controllers is analyzing a same content item for controlling at least one light characteristic of said lighting device based on said analysis, determining said controller, of said plurality of controllers, to which control of said at least one light characteristic of said lighting device is to be allocated to, allocating said control to said controller, and preventing control of said at least one light characteristic of said lighting device by any other controller of said plurality of controllers.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on a local computer, partly on the local computer, as a stand-alone software package, partly on the local computer and partly on a remote computer, or entirely on the remote computer or server. In the latter scenario, the remote computer may be connected to the local computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 is a flow diagram of a first embodiment of the method;

FIG. 4 is a flow diagram of a second embodiment of the method;

FIG. 5 is a flow diagram of a third embodiment of the method; and

FIG. 6 is a block diagram of an exemplary data processing system for performing the method of the invention.

Corresponding elements in the drawings are denoted by the same reference numeral.

### DETAILED DESCRIPTION OF THE EMBODIMENTS

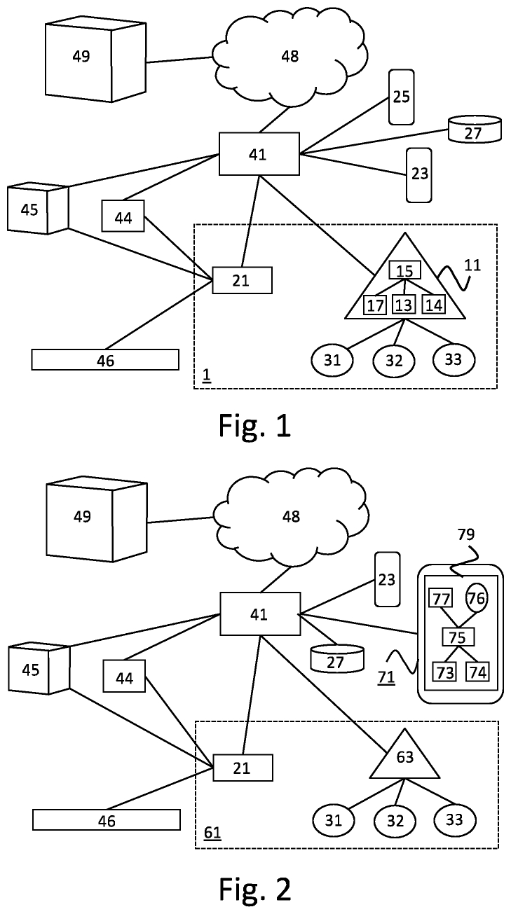

FIG. 1 shows a first embodiment of the system for allocating control of a lighting device to a controller of a plurality of controllers. In this first embodiment, the system is a bridge 11. In the example of FIG. 1, the bridge 11 is part of a lighting system 1.

The lighting system 1 further comprises an HDMI module 21 and three wireless lighting devices 31-33. The bridge 11 communicates with the lighting devices 31-33 using a wireless communication protocol like e.g. Zigbee. The bridge 21 may be a Hue bridge and the lighting devices 31-34 may be Hue lamps, for example.

The HDMI module 21 may be a Hue Play HDMI Sync Box, for example. The HDMI module 21 can control the lighting devices 31-33 via the bridge 11. The HDMI module 21 is connected to a display device 46, a local media receiver 44 and a PC 45 via HDMI. The local media receiver 44 may comprise a streaming and/or content generation device, e.g. an Apple TV, Microsoft Xbox One and/or Sony PlayStation 4, and/or a cable and/or satellite TV receiver. The local media receiver 44 and the PC 45 may be able to receive content from a media server 49 and/or from a media server in the home network.

The bridge 11 is connected to the wireless LAN access point 41, e.g. using Wi-Fi or Ethernet. The HDMI module 21 is also connected to a wireless LAN access point 41, e.g. using Wi-Fi. In the example of FIG. 1, the HDMI module 21 communicates with the bridge 11 via the wireless LAN access point 41, e.g. using Wi-Fi. Alternatively or additionally, the HDMI module 21 may be able to communicate directly with the bridge 11 e.g. using Zigbee, Bluetooth or Wi-Fi technology, and/or may be able to communicate with the bridge 11 via the Internet/cloud. The wireless LAN access point 41 is connected to the Internet 48. The media server 49 is also connected to the Internet 48. Media server 49 may be a server of a video-on-demand service such as Netflix, Amazon Prime Video, Hulu, Disney+ or Apple TV+, for example.

When a user starts playback of video content on the PC 45 and has activated an entertainment mode in an app running on the PC 45 (e.g. the Hue Sync app), this app will analyze the video content and control one or more of the lighting devices 31-33 based on this analysis. An output of the PC 45 is connected to an input of the HDMI module 21. After the user has selected the PC 45 as input source on the HDMI module 21, the HDMI module 21 provides the video content received from the HDMI module 21 to the display device 46. Additionally, the HDMI module 21 analyzes the video content and controls one or more of the lighting devices 31-33 based on this analysis. The HDMI module 21 and the PC 45 are referred to as (entertainment lighting) controllers.

In this situation, it might happen that entertainment light effects are being generated by:
the app running on the PC 45, from where the user is streaming the video content;
the HDMI module 21, which analyzes the video content received from the PC 45 via the HDMI cable on its way to the display device 46.

This might lead to three inconsistencies in the light effects:
1. Repetition of messages and suboptimal use of network bandwidth, as there are two controllers that render seemingly similar effects;
2. Delays/latency, since the HDMI module 11 performs additional processing for e.g. reading/decoding HDMI that the app on the PC 45 does not need to do;
3. Differences in the algorithms that can lead to slightly different light effects for the same input data.

When the network traffic is throttled/filtered by the bridge 11 and both algorithms are similar, then dealing with the delays/latency is the issue to solve to prevent that the user experience is degraded.

The bridge 11 comprises a receiver 13, a transmitter 14, a processor 15, and memory 17. The processor 15 is configured to detect, via the receiver 13, that each of the controllers, i.e. both the HDMI module 21 and the PC 45, are analyzing a same content item for controlling a common lighting device, e.g. one or more of the lighting devices 31-33, based on the analysis. The processor 15 is further configured to determine the controller, of the two controllers, to which control of the common lighting device is to be allocated to, allocate the control to this controller, and prevent control of the common lighting device by the other controller of the two controllers.

In order to solve the delays/latency issue, the bridge 11 may decide that only the device with the best timing performance takes the lead and the other is (temporarily) disabled, i.e. prevented from controlling the lighting device(s). If the processing time of the HDMI module 21 is higher than that of the PC 45, then the app running on the PC 45 takes the lead. However, the bridge 11 may also determine that the PC 45 fluctuates in terms of performance as a result of other tasks/programs are running, which means that the latency between video frame and rendering of the corresponding light effect(s) is not constant (even though the delay is lower than if the light effect(s) would be rendered by the HDMI module 21). The bridge 11 may decide that a consistent delay is preferred to faster but changing delays and allocate control to the HDMI module 21.

Alternatively or additionally, the bridge 11 may take the capabilities of the controllers, i.e. PC 45 and the HDMI module 21, into account. For example, the (algorithm performed on the) HDMI module 21 may only be able to process data in real time without really knowing what data it is going to receive in the future. On the other hand, the (algorithm performed on the) PC 45 may be able to get access to the complete video content, or at least to a certain number of seconds or frames in the future. This means that the PC 45 can better prepare light transitions in between scenes of the video content and/or transition in a smooth way when advertisements appear, for example.

In the embodiment of FIG. 1, the processor 15 is further configured to instruct, via the transmitter 14, the other controller of the two controllers not to control the common lighting device. For example, when the bridge 11 detects that both the HDMI module 21 and the PC 45 controls, or wants to control, the lighting device 31 based on an analysis of the same content item, the bridge 11 allocates control to one of them and instructs the other controller not to control the lighting device 31, e.g. by sending a message using a standardized protocol.

In the example described above in relation the HDMI module 21 and the PC 45, one or more of the lighting devices 31-33 are controlled based on an analysis of video content. The same allocation of control may also be used when one or more of the lighting devices 31-33 are controlled based on an analysis of audio content. For example, when a mobile device 23 runs an app that streams songs via a smart speaker 27 and controls lighting device 31 based on an analysis of these songs and a mobile device 25 runs an app that controls lighting device 31 based on an analysis of a microphone signal (and as a result, based on the audio content rendered by the smart speaker 27), the bridge 11 allocates control to one of the mobile devices and instructs the other controller not to control the lighting device 31.

In the examples described above, the display device 46 is not an entertainment lighting controller itself Alternatively, the display device 46 may also be a controller. For example, the display device 46 may be a TV running a suitable (e.g. Android) app. This makes it possible to use certain other criteria for determining which controller to allocate to a lighting device. The delay and/or variation in delay may still be used as criterion, but an app running natively on a TV may get access to different types of metadata.

For example, the app running on the TV might notice that the user has changed visualization settings in the TV (e.g. gamma color, contrast, brightness) and may be able to benefit from this information to generate better light effects. This is information that the PC 45 might not be able to get access to or might be able to get access to but at an integrally higher delay. Additionally or alternatively, the app running on the TV might be able to get access to menu information which is displayed on the TV overlaid over the video, but which is not accessible to the PC 45. Thus, if the bridge 11 allocates control to the TV, additional metadata for light effects may be available.

If the TV is a controller, it typically renders the content that it is analyzing. However, this is not required. For example, if audio and video content is rendered on a mobile device, e.g. mobile device 23 or 25, the display device 46 may analyze the video content and control one or more of the lighting devices 31-33 based on this analysis.

It is advantageous to not just analyze video content, but to also analyze audio content. In this case, it is beneficial to perform the audio analysis on the mobile device. For instance, the content being streamed on a phone will include not just video content for analysis but also audio. The audio can be used for fingerprinting but also to adjust light effects (e.g. a white flash without sound might be represented differently than if there is also a loud bang associated to it). In this situation, the bridge 11 may allocate control of a first lighting device based on an analysis of the video content to the display device 46 and allocate control of a second lighting device based on an analysis of the audio content to the mobile device 23 or 25.

This also applies to other rendering devices. For example, if audio and video content is rendered on the display device 46, e.g. a TV, the mobile device 23 or 25 may analyze the audio content and control one or more of the lighting devices 31-33 based on this analysis. This allows the display device 46 to focus solely on the analysis of the video content. The mobile device 23 or 25 can the use its microphone to receive the audio output by the display device 45. This may be beneficial, because a controller close to the user might be more representative of how the user experiences the sound locally, as other noise sources might interfere with how the user experiences the sound.

In the embodiment of the bridge 11 shown in FIG. 1, the bridge 11 comprises one processor 15. In an alternative embodiment, the bridge 11 comprises multiple processors. The processor 15 of the bridge 11 may be a general-purpose processor, e.g. ARM-based, or an application-specific processor. The processor 15 of the bridge 11 may run a Unix-based operating system for example. The memory 17 may comprise one or more memory units. The memory 17 may comprise solid-state memory, for example.

The receiver 13 and the transmitter 14 may use one or more wired or wireless communication technologies such as Ethernet or Wi-Fi to communicate with the wireless LAN access point 41 and Zigbee to communicate with the lighting devices 31-33, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 13 and the transmitter 14 are combined into a transceiver.

The bridge 11 may comprise other components typical for a consumer electronic device such as a power connector. The invention may be implemented using a computer program running on one or more processors. In the embodiment of FIG. 1, the system is a bridge. In an alternative embodiment, the system may be another device, e.g. a mobile device or a PC. In the embodiment of FIG. 1, the system comprises a single device. In an alternative embodiment, the system comprises multiple devices.

FIG. 2 shows a second embodiment of the system for allocating control of a lighting device to a controller of a plurality of controllers. In this second embodiment, the system is a mobile device 71. The mobile device 71 may be a mobile phone or a tablet, for example. A user may be able to use an app running on mobile device 71 to control the lighting devices 31-33 via the wireless LAN access point 41 and a bridge 63. In the embodiment of FIG. 2, the lighting devices 31-33 are controlled via the bridge 63. In an alternative embodiment, the lighting devices 31-33 are controlled without a bridge, e.g. directly via Bluetooth or via the wireless LAN access point 41. Optionally, the lighting devices 31-33 are controlled via the cloud. The lighting devices 31-33 may be capable of receiving and transmitting Wi-Fi signals, for example.

The mobile device 71 may control one or more of the lighting devices 31-33 based on an analysis of audio content and/or video content, but this is not required. Like the bridge 11 of FIG. 1, the mobile device 71 does not need to be a controller itself but may just be able to detect that multiple controllers are analyzing the same content item and are controlling a common lighting device based on this analysis.

In the example of FIG. 2, like in the example of FIG. 1, when a user starts playback of video content on the PC 45 and has activated an entertainment mode in an app running on the PC 45, this app will analyze the video content and control one or more of the lighting devices 31-33 based on this analysis. After the user has selected the PC 45 as input source on the HDMI module 21, the HDMI module 21 provides the video content to the display device 46. Additionally, the HDMI module 21 analyzes the video content and controls one or more of the lighting devices 31-33 based on this analysis.

The mobile device 71 comprises a receiver 73, a transmitter 74, a processor 75, a microphone 76, a memory 77, and a display 79. The processor 75 is configured to detect, via the receiver 73, that each of the controllers, i.e. both the HDMI module 21 and the PC 45, are analyzing a same content item for controlling a common lighting device, e.g. one or more of the lighting devices 31-33, based on the analysis. The processor 75 is further configured to determine the controller, of the two controllers, to which control of the common lighting device is to be allocated to, allocate the control to this controller, and prevent control of the common lighting device by the other controller of the two controllers.

In the embodiment of FIG. 2, the processor 75 is configured to instruct, via the transmitter 74, an intermediate node, i.e. bridge 63, to prevent the control of the lighting device by the other controller of the two controllers. For example, if the bridge 63 receives a command for a certain lighting device from a controller that should be prevented from controlling this certain lighting device, the bridge 63 may decide not to forward this command to this certain lighting device.

In an alternative embodiment, the processor 75 is configured to instruct, via the transmitter 74, the other controller of the two controllers not to control the common lighting device. If the mobile device 71 receives an audio signal comprising a representation of the audio content reproduced by the smart speaker 27 via microphone 76, analyzes this audio signal and controls the lighting device 31 based on this analysis, and mobile device 23 also controls lighting device 31 based on an analysis of the same audio content, the mobile device 71 may allocate control to the mobile device 23. In this case, the mobile device 71 does not need to transmit an instruction to the other controller, because the mobile device 71 is the other controller.

In the embodiment of the mobile device 71 shown in FIG. 2, the mobile device 71 comprises one processor 75. In an alternative embodiment, the mobile device 71 comprises multiple processors. The processor 75 of the mobile device 71 may be a general-purpose processor, e.g. from ARM or Qualcomm or an application-specific processor. The processor 75 of the mobile device 71 may run an Android or iOS operating system for example. The display 79 may comprise an LCD or OLED display panel, for example. The display 79 may be a touch screen display, for example. The memory 77 may comprise one or more memory units. The memory 77 may comprise solid state memory, for example.

The receiver 73 and the transmitter 74 may use one or more wireless communication technologies such as Wi-Fi (IEEE 802.11) to communicate with the wireless LAN access point 41, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 73 and the transmitter 74 are combined into a transceiver. The mobile device 71 may further comprises a camera (not shown). This camera may comprise a CMOS or CCD sensor, for example. The mobile device 71 may comprise other components typical for a mobile device such as a battery and a power connector. The invention may be implemented using a computer program running on one or more processors.

In the embodiments of FIGS. 1 and 2, control is not allocated per light characteristic or per set of one or more light characteristics but per lighting device and is therefore the same for all light characteristics of a lighting device. In an alternative embodiment, control is allocated per light characteristic or per set of one or more light characteristics.

A first embodiment of the method of allocating control of a lighting device to a controller of a plurality of controllers is shown in FIG. 3. A step 101 comprises detecting that each of a plurality of controllers is analyzing a same content item for controlling at least one light characteristic of a lighting device based on the analysis of this content item. A step 103 comprises determining the controller, of the plurality of controllers, to which control of the at least one light characteristic of the lighting device is to be allocated to. A step 105 comprises allocating the control to the controller. A step 107 comprises preventing control of the at least one light characteristic of the lighting device by any other controller of the plurality of controllers. Step 101 is repeated after step 107, after which the method proceeds as shown in FIG. 3.

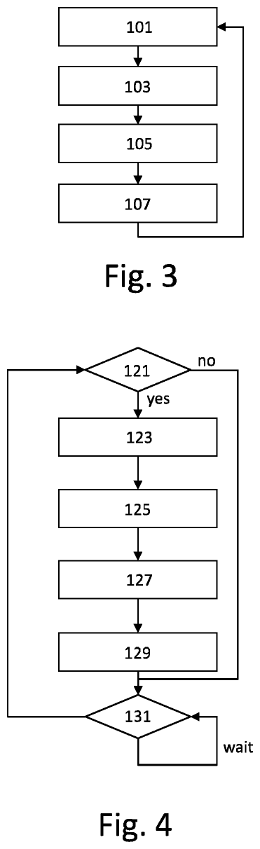

A second embodiment of the method of allocating control of a lighting device to a controller of a plurality of controllers is shown in FIG. 4. A step 121 comprises determining whether each of a plurality of controllers is either analyzing a same content item for controlling at least one common lighting device of a plurality of lighting devices based on the analysis, or desires to do so. If it is detected in step 121 that that a plurality of controllers is analyzing a same content item for controlling at least one common lighting device based on the analysis, or desires to do so, a step 123 is performed next. If not, steps 123-129 are skipped and a step 131 is performed next.

Step 123 comprises determining a current load of each of the plurality of controllers. A step 125 comprises determining to which of the plurality of controllers control of the lighting device should be allocated to based on the loads determined in step 123 and selecting this controller. The controller with the smallest load is selected in step 125. The selected controller may be the same or different than the controller selected in the previous iteration of step 125.

A step 127 comprises allocating the control of the plurality of lighting devices to the controller selected in step 125. A step 129 comprises preventing control of the plurality of lighting devices by any other controller (than the selected controller) of the plurality of controllers. Step 129 typically comprises transmitting one or more messages. Step 131 is performed after step 129. Step 131 comprises waiting for a predetermined time to elapse. If the predetermined time has elapsed, step 121 is repeated and the method proceeds as shown in FIG. 4. A result of this method is that the loads of the controllers are regularly reevaluated, and control is allocated to another controller when it is beneficial.

In the embodiment of FIG. 4, all lighting devices that are controlled based on an analysis of the same content item are controlled by the same controller. In an alternative embodiment, different lighting devices are controlled by different controllers and a controller may be determined based on a current load for one or more of these lighting devices.

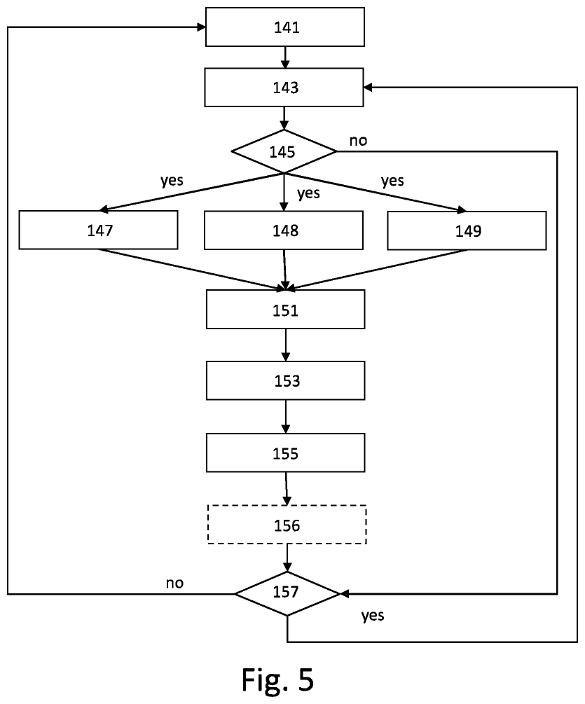

A third embodiment of the method of allocating control of a lighting device to a controller of a plurality of controllers is shown in FIG. 5. A step 141 comprises detecting whether an entertainment mode has been activated, e.g. for a certain content item. Next, in the first iteration of a step 143, a first lighting device is selected.

A step 145 comprises determining whether each of a plurality of controllers is either analyzing a same content item for controlling the lighting device selected in step 143 based on the analysis, or desires to do so. If it is detected in step 145 that that a plurality of controllers is analyzing a same content item for controlling the selected lighting device based on the analysis, or desires to do so, a step 147, a step 148, and/or a step 149 is/are performed next. If not, steps 147-156 are skipped and a step 157 is performed next.

Step 147 comprises comparing the algorithms used by the controllers detected in step 145 and/or comparing processing characteristics, processing capabilities and/or access to display settings and/or menu information of the controllers detected in step 145. Step 148 comprises determining a characteristic of the content item. Step 149 comprises determining a position of the selected lighting device, e.g. relative to a display device and/or relative to the controllers detected in step 145.

A step 151 comprises determining to which of the controllers detected in step 145 control of the selected lighting device should be allocated to based on the comparison(s) of step 147, the determination of the characteristic in step 148, and/or the determination of the position in step 149. Step 151 further comprises selecting this controller. This controller may be the same as or different from a controller selected for another lighting device. A step 153 comprises allocating the control of the selected lighting device to the controller selected in step 151.

As a first example of different controllers being selected for different lighting devices, the controller that is nearest to the selected lighting device (of the controllers detected in step 145) may be allocated to the selected lighting device. As a second example, a first lighting device may be (most) suitable for rendering light effects of a first type and a second lighting device may be (most) suitable for rendering light effects of a second type, and a first controller may be allocated to the first lighting device and a second controller may be allocated to the second lighting device.

Next, a step 155 comprises preventing control of the selected lighting device by any other controller (than the selected controller) of the controllers detected in step 145, i.e. of the controllers which analyze a same content item for controlling this lighting device based on the analysis or which desire to do so. Unless the method of FIG. 5 is performed by the other controller and there is only one other controller, step 155 may comprise instructing the other controller(s) not to control the selected lighting device or instructing an intermediate node to prevent the control of the selected lighting device by the other controller(s).

An optional step 156 comprises instructing the controller selected in step 151 to start or keep controlling the lighting device selected in step 143 based on the analysis of the content item. Step 157 is performed after step 155 or after optional step 156.

Step 157 comprises checking whether all lighting devices have been selected in step 143 (in the current iteration or in previous iterations of step 143 in the current loop). If so, step 141 is performed next and step 143 is then performed again for the first lighting device in the next loop when the entertainment mode is detected to have been activated for another content item. In an alternative embodiment, steps 143-157 are repeated more frequently, e.g. in case another controller becomes active while the entertainment mode has already been active for a while. If all lighting devices have not yet been selected in the current loop, and therefore, not all lighting devices have there been allocated a controller, the next lighting device is selected in step 143 and the method then proceeds as shown in FIG. 5.

The embodiments of FIGS. 3 to 5 differ from each other in multiple aspects, i.e. multiple steps have been added or replaced. In variations on these embodiments, only a subset of these steps is added or replaced and/or one or more steps is omitted. For example, step 156 of FIG. 5 may be added to the embodiment of FIG. 4. The embodiments of FIGS. 4 and 5 may be combined into a single embodiment.

In the embodiments of FIGS. 4 and 5, control is not allocated per light characteristic or per set of one or more light characteristics but per lighting device and is therefore the same for all light characteristics of a lighting device. In an alternative embodiment, control is allocated per light characteristic or per set of one or more light characteristics.

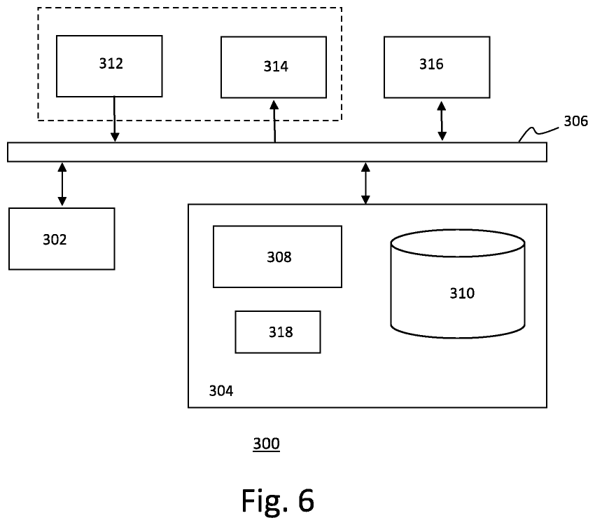

FIG. 6 depicts a block diagram illustrating an exemplary data processing system that may perform the method as described with reference to FIGS. 3 to 5.

As shown in FIG. 6, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 6 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 6, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 6) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for allocating control of a lighting device to a controller of a plurality of controllers, said system comprising:
at least one input interface; and
at least one processor configured to:
detect, via said at least one input interface, that each of said plurality of controllers is analyzing a same video and/or audio content, for controlling at least one light characteristic of said lighting device based on said analysis,
determine said controller, of said plurality of controllers, to which control of said at least one light characteristic of said lighting device is to be allocated to, allocate said control to said controller, and
prevent control of said at least one light characteristic of said lighting device by any other controller of said plurality of controllers.

2. A system as claimed in claim 1, wherein said system further comprises at least one output interface and said at least one processor is configured to instruct, via said at least one output interface, an intermediate node to prevent said control of said at least one light characteristic of said lighting device by said any other controller of said plurality of controllers.

3. A system as claimed in claim 1, wherein said system further comprises at least one output interface and said at least one processor is configured to instruct, via said at least one output interface, said any other controller of said plurality of controllers not to control said at least one light characteristic of said lighting device.

4. A system as claimed in claim 1, wherein said at least one processor is configured to allocate said control to said controller based on a comparison between an algorithm used by said controller for said analysis and any corresponding algorithm used by said any other controller for said analysis.

5. A system as claimed in claim 1, wherein said at least one processor is configured to allocate said control to said controller based on a comparison between a processing characteristic, processing capability and/or access to display settings and/or menu information of said controller with any corresponding processing characteristic, processing capability and/or access to display settings and/or menu information of said any other controller.

6. A system as claimed in claim 1, wherein said at least one processor is configured to allocate said responsibility to said controller based on a characteristic of said content item.

7. A system as claimed in claim 1, wherein said at least one processor is configured to:
detect that a further controller of said plurality of controller is analyzing said content item for controlling at least one light characteristic of a further lighting device based on said analysis,
allocate control of said at least one light characteristic of said further lighting device to said controller,
prevent control of said at least one light characteristic of said further lighting device by any controller other than said controller.

8. A system as claimed in claim 7, wherein said system further comprises at least one output interface and said at least one processor is configured to instruct, via said at least one output interface, said controller to control said at least one light characteristic of said further lighting device.

9. A system as claimed in claim 1, wherein said at least one processor configured to:
detect that a further controller of said plurality of controllers is analyzing said content item for controlling at least one light characteristic of a further lighting device based on said analysis,
allocate control of said at least one light characteristic of said further lighting device to said further controller, and
prevent control of said at least one light characteristic of said further lighting device by any controller other than said further controller.

10. A system as claimed in claim 9, wherein said at least one processor is configured to:
allocate said control of said at least one light characteristic of said lighting device to said controller based on a position of said lighting device, and
allocate said control of said at least one light characteristic of said further lighting device to said further controller based on a position of said further lighting device.

11. A system as claimed in claim 9, wherein said at least one processor is configured to:
allocate control of said at least one light characteristic of said lighting device for rendering light effects of a first type to said controller; and
allocate control of said at least one light characteristic of said further lighting device for rendering light effects of a second type to said further controller.

12. A system as claimed in claim 1, wherein said at least one processor is configured to:
allocate said control of said at least one light characteristic of said lighting device to said controller at a first moment,
prevent said control of said at least one light characteristic of said lighting device by any controller other than said controller upon allocating said control to said controller,
allocate said control of said at least one light characteristic of said lighting device to a further controller of said plurality of controllers at a second moment, and
prevent control of said at least one light characteristic of said lighting device by any controller other than said further controller upon allocating said control to said further controller.

13. A system as claimed in claim 12, wherein said at least one processor is configured to:
allocate said control of said at least one light characteristic of said lighting device to said controller at said first moment based on a load of said controller and/or a load of said further controller at said first moment, and
allocate said control of said at least one light characteristic of said lighting device to said further controller at said second moment based on a load of said controller and/or a load of said further controller at said second moment.

14. A method of allocating control of a lighting device to a controller of a plurality of controllers, said method comprising:
detecting that each of said plurality of controllers is analyzing a same video and/or audio content for controlling at least one light characteristic of said lighting device based on said analysis;
determining said controller, of said plurality of controllers, to which control of said at least one light characteristic of said lighting device is to be allocated to;
allocating said control to said controller; and
preventing control of said at least one light characteristic of said lighting device by any other controller of said plurality of controllers.

15. A non-transitory computer-readable medium on which are stored a plurality of non transitory computer-readable instructions that when executed on a processor are configured to perform the steps comprising the method as defined in the method as defined in claim 14.
